(19) United States
(12) Patent Application Publication
(10) Pub. No.: US 2012/0328747 A1
(43) Pub. Date: Dec. 27, 2012

(54) High Viscosity Foods Processor

(76) Inventor: David Levy, Berkeley, CA (US)

(21) Appl. No.: 13/337,069

(22) Filed: Dec. 24, 2011

Related U.S. Application Data
(60) Provisional application No. 61/427,168, filed on Dec. 24, 2010.

(51) Int. Cl. A23P 1/00; B67D 7/06; A23G 3/50; A47J 37/10; A21D 6/00; A23G 3/02

(52) U.S. Cl. 426/231; 99/423; 99/353; 222/23

(57) ABSTRACT

A device and method for producing individualized meals according to the visual desires of each diner at a restaurant. Reservoirs of viscous foodstuff is deposited by an XY or XYZ plotter to simulate edible images and then cooked prior to diners immediately consuming them. The high-volume system includes a rotary shuttle table that contemporaneously prints, cooks, flips and dispenses food products, especially pancakes. Patrons draw images using drawing implements whose colors coincide with the viscous foodstuffs in the reservoirs. These images are digitally scanned and the data is used to drive the XY plotter thereby enabling colored printed food to correlate with images drawn by patrons immediately prior to ordering.

This application claims the benefit of the filing date of provisional application 61/427,168, filed Dec. 24, 2010. The contents of this prior application is incorporated herein as if entirely set forth.

### TECHNICAL FIELD

This disclosure relates to devices and methods for ornamental preparation of foods for display and/or consumption.

### BACKGROUND

Caterers and restaurateurs constantly seek to provide their customers innovative presentations of their delicious recipes, to enhance the overall enjoyment of their foods, to advance the art of cooking and to increase the value of their services. Ideally the presentation would go beyond “innovative,” all the way to “Customized.” The problem is two-fold: 1) meticulous food preparation can be extremely time consuming, and the objective is typically to produce good looking food as fast as possible, not to produce great-looking food and 2) Chefs with this level of skill are hard to find and much more expensive than those of lesser skills. It is therefore desirable to allow chefs of moderate skills to produce both highly ornamental and also customized foods quickly and at low cost. Kitchens are crowded and space is at a premium. These issue exist with highly viscous foods, such as candy, chocolate or other confection in the molten state, pretzel dough, bread dough, pastry dough, pancake batter, and the like—obviously in preparation of making foods such as confections, pretzels, bread, pastries, pancakes, and the like. Also, space in a professional kitchen is highly valuable. There is great competition for each tool to justify its space in the kitchen.

Therefore, it is desirable to enable cooks who have lesser artistic skills (and who are, by definition, more prevalent than those with higher artistic skills), to create food of viscous origin that demonstrates a high degree of artistry. It is further desirable to enable lower-paid cooks to create foods that would otherwise require higher paid cooks. It is further desirable that such a device be small and portable. It is further desirable that such a device be able to be disposed above a hot griddle. It is further desirable that such a device be able to sit directly on the surface of a griddle at full temperature. It is further desirable that such a device can interface with a personal computer. It is further desirable that such a device can quickly produce customized presentations that will appeal to the at-the-moment desires of each of a plurality of individuals, especially children. It is desirable to enable a diner to enter a restaurant with a customized image or to produce, and to eat a meal that incorporates the image moments later. It is further desirable that such a device be capable of developing its own production algorithms based on an image alone. It is further desirable that such a device support operation of multiple colors, multiple materials, and/or provide more than one orifice size. It is further desirable that such a device can quickly and easily change between different colors, materials and/or orifice sizes. It is further desirable to enable customized foods to be made, especially pancakes, in such a way as to not require a device to occupy space on the cooking area. It is further desirable to c customize colors and materials of food for each diner, on the fly and without handwork by the cook. It is further desirable to provide an integrated system that allows highly individualized meals to prepared from fresh materials at high-speed and low-cost. Is further desirable to provide a system that fits on a standard 24 inch counter. It is further desirable to provide finely detailed high-resolution custom images with foodstuffs of standard thickness.

### SUMMARY

The limitations described above are superseded, and objects and advantages achieved as described below.

An important aspect of this invention is the “event” of a restaurant or other food preparer responding to the desires of the patrons in real time to provide customized meals based on an image selected or created by each individual diner without preparation prior to the patron arriving for the meal. Facilitating this objective requires a highly efficient and flexible system.

One of the key opportunities seen as ideal for this application is pancakes. The economics of a significant segment of the restaurant business is largely driven by appealing to children, because the desires of children often dictate where the family chooses to eat. Therefore a device that enables restaurants to appeal to the children has the ability to steer family restaurant choice and therefore has value far beyond simply providing a fun or innovative meal to a diner after they have sat to eat. Such a device has the ability to change the economics of the restaurant by bringing entire families that otherwise would not have attended. The device therefore has the ability to sell meals to customers who don't even eat the product the device creates. Pancakes are therefore an ideal application from a “big picture” economic standpoint: children love pancakes and this invention enables pancakes to appeal to children more than ever before.

Focusing on pancakes for a moment, at the highest level, two basic approaches of pancake making device are envisioned. The first is a grill-mountable device that is both portable and light. By utilizing the existing griddle (as opposed to introducing its own heating elements) the device enables the cook to save space which is critical in any professional kitchen. The device utilizes multiple reservoirs of different colors of pancake batter and an XY or an XYZ plotter to deposit extrusions or individual dots of specific colors of batter from the reservoirs to very specific locations on the grill in order to reproduce any desired image. In one embodiment the reservoirs are pressurized and solenoid valves are used to dispense measured portions of batter from each reservoir in an open loop time-based dispensing system. A camera or other sensor may be used to close the loop by observing the flow. In another embodiment a screw is used to control the flow. Again, open loop or closed. Dispensing viscous materials is known in the art, as is XY controllers, interface (which may be affected wirelessly and/or through USB if a standalone computer is used as the interface) and the mathematics of compensating for the offset between multiple heads and an intended target.

Providing high-resolution images in pancake batter requires lines to be relatively thin, which in turn requires the colored portion of the pancake to be relatively short because the pancake batter extrusion has a height to width ratio of approximately 1:1. This problem is addressed by creating a double level pancake in which the second level is a quick superposition, potentially of a single color directly above the initial lower-level multicolor image. For related reasons, the good surface in a printed pancake is the lower surface, therefore the pancake is produced with the good side facing downwards, or upside down. The interface of the device allows the cook to select from a wide variety of preprogrammed images, such as animals, birthday cakes, hearts for Valentines Day, etc. All images may be augmented with customized text, such as the names of the couple for Valentines or anniversaries, the date, the score of the winning game, the age and, of course, the name of the child. The cook or patron may select font, bolding and italics etc. Additionally, it is possible for patrons to provide images which are scanned in one embodiment for diners to draw an image at the table prior to ordering their food utilizing drawing implements provided by the restaurant. The colors of the drawing implements will coincide with the colors of the foodstuff in the machine so that there is a ready-made color correlation between images and the food that is available to be prepared. However, to address the limitations of color, one embodiment the device is capable of producing more colors than available in the reservoirs by mixing valve that may be incorporated between two colors or materials of batter (or other foodstuff). By dispensing selected ratios between two colors the device may produce a very wide range of mixed colors at the output. After producing a customized color in this manner the mixing device needs to be purged into waste area located within the device.

A second basic implementation is a higher volume device that is self-contained to provide many pancakes or other foodstuff to many patrons. This device utilizes a shuttle system with multiple stations in which one station is printing a pancake while another is heating while another is dispensing finished pancakes. This allows a high-volume of customized product to be produced. The cook is responsible for inputting the graphic selections and related text as well as maintaining operation of the machine including filling reservoirs as they become empty. The preferred system is based on a rotary table however a shuttle system utilizing individual transfer cars rolling on wheels is also contemplated. The printing mechanics are not inherently different than the griddle version described above. Heating however is dramatically different. Rather than the human cook perform the flipping operation the pancake (or other food), cooking is performed automatically by series of heat (or cold) sources they create the phase change. In the automatic system actuators move the phase change sources toward the lower and upper surfaces of the pancake in order to affect cooking. These sources may have different temperatures and different timing and all controlled under the same processor that operates the printer. As the system advances to the dispensing area, the shuttle is flipped and deformed (either by bending or stretching) thereby breaking the adhesion and causing the pancake or other foodstuffs to fall out of the device, ready-to-eat. The application explains several different embodiments of the relationship between printing and changing the phase of the material to its edible state. The system also produces high-volume of similar pancakes for a party, corporate event, school, tradeshow, convention, with a logo specific to a company, movie premiere, etc. In this manner the device may be used as a marketing or advertising medium.

In one embodiment, the system includes: a printing station that includes an XY plotting mechanism dispensing viscous foodstuffs of different materials and/or colors stored in a plurality of reservoirs as an extrusion or as discrete elements wherein the printing station includes a phase change element of a first magnitude such that a multi-materialed or multicolored edible image selected by a diner may be printed; a phase change station including at least one phase change element of a second magnitude in which the second magnitude is significantly greater than the first magnitude and that translates orthogonal to the XY plane of the plotting mechanism thereby cooking said edible image; a transfer plate onto which said edible image is printed prior to transferring to the phase change station prior to transferring to a dispensing station such that said edible image may be released by bending or stretching the transfer plate such that the diner may consume an image selected immediately prior to ordering a meal in which each motion is under control of common controller. In one embodiment, a diner may draw an image that is scanned to create a digital representation utilized to drive the XY plotting mechanism such that the diner may consume a meal the diner drew immediately prior to ordering the meal.

While this summary has focused on pancakes similar objects and advantages may be realized with other foods, such as cakes, cake icing, chocolate, confections, custards, ice cream, vegetables, bread dough and the like

### DESCRIPTION OF DRAWINGS

FIG. 1 shows a numerically controlled viscous food preparation device.

FIG. 2 shows an embodiment of printing shuttle.

FIG. 3 shows a control valve in a closed state.

FIG. 4 shows a control valve in a first of two actuated states.

FIG. 5 shows a pancake of an American flag in the wind.

FIG. 6 shows a method for cooking pancakes processed with numeric control.

FIG. 7 shows a flow chart of a diner eating a food processed into a custom shape without prior planning.

FIG. 8 shows a staged processing self-contained viscous food printing system.

FIG. 9 shows a mixing tube.

FIG. 10 shows a two level printed foodstuff.

FIG. 11 shows a customized restaurant service.

FIG. 12 shows a transfer shuttle with wheels.

Like reference symbols in the various drawings indicate like elements.

### DETAILED DESCRIPTION

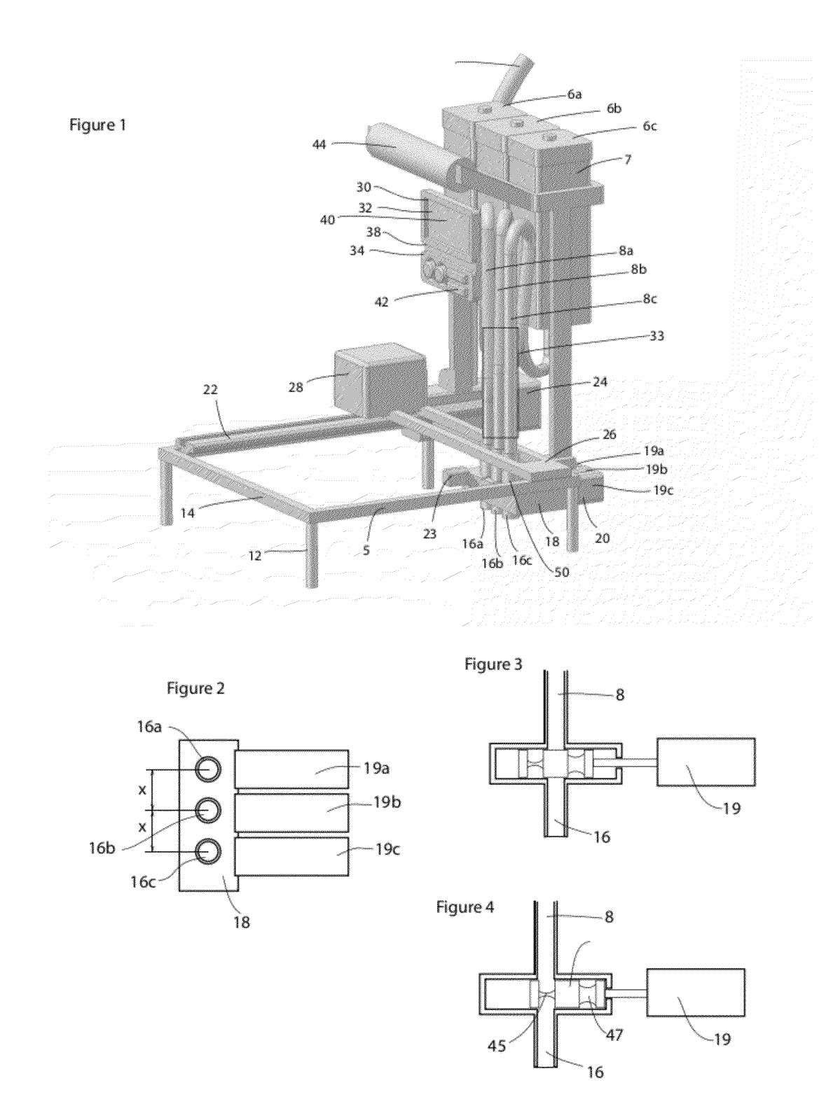

FIG. 1 shows a processor 5 for the preparation of foods made from foodstuffs that are highly viscous in their uncooked state. (Note that for the purposes of better visualization, the “skin” of the product has been removed.) Examples of such foods are: candy in the molten state, pretzel dough, bread dough, a ground vegetable mixture, pastry dough, and pancake batter. This embodiment shows three reservoirs, 6a, 6b, 6c, each containing “ready to portion” bulk viscous foodstuffs used in the preparation of one or more recipes. Examples of the types of variations between foodstuffs in the three reservoirs: different colors of pancake batter (e.g. undyed, dyed red, and dyed blue); different kinds of pretzel dough (e.g. rye flour, wheat flour, sourdough); different kinds of ground or mashed vegetable mixtures (e.g. potato, carrot, broccoli). The foodstuffs in each reservoir 6 are not limited to being of similar types. “Ready to portion” is defined as the stage in food preparation after the raw ingredients have been measured, mixed and otherwise prepared so that the next step is to arrange the bulk foodstuffs into the shape the consumer will be provided. In one embodiment the foodstuffs in each reservoir 6 are pressurized such as by a spring-loaded plunger mechanism 7 disposed within each reservoir 6. The pressure required will vary as a function of the type of foodstuffs involved, with higher viscosities requiring a higher pressure.

Delivery tubes 8 protrude from the bottom of reservoirs 6, and terminate at release nozzles 16, disposed on printing shuttle 18. The activation of each release nozzle 16 is directed by controller 30. Sensors 4, one located in each reservoir 6 senses when the reservoirs is getting low, and signals the cook to refill the reservoir 6. In this embodiment solenoids 19a, 19b, and 19c (FIGS. 3 and 4) control release nozzles 16a, 16b, 16c. Printing shuttle 18 is actuated to move within the region of frame 14 by an XY plotting mechanism 20. In this embodiment XY plotting mechanism 20 includes a linear guide/positioning sensor in a first axis 22, a first actuator 24, a linear guide/positioning sensor in a second axis 26, and a second actuator 28, to activate printing shuttle 18. XY plotting mechanism 20 is driven by a controller 30 (here shown within an interface housing 32). Such electromechanical plotting mechanisms are well-known in the art. Delivery tubes 8 are flexible and sufficient in length to allow printing shuttle 18 to traverse the full range of XY plotting mechanism 20. In one embodiment, XY plotting mechanism 20 is controlled through a USB (Universal serial bus) 38 or like interface by a personal computer. In one embodiment processing unit 34 is disposed within food processor 5 and Universal serial bus USB 38 or a wireless connection is used to download files from a personal computer, so that the computer does not need to remain in the kitchen. In another embodiment the computer is integrated into food processor 5.

Controlling the flow of a viscous material is well-known in the art and can be effectively implemented with: material flow sensors 21 disposed proximate to release nozzles 16, open loop control based on the foodstuffs being within a range of viscosity, or optically with a camera 23. In one embodiment the device dispenses material “continuously” (meaning without waiting for the phase change process to complete), essentially extruding the foodstuff from each resevoir 6 on the surface, such as a transfer sheet 70/shuttle 104. A “transfer sheet” (or transfer shuttle) are both here defined as being incapable of itself producing the phase change of cooking or otherwise preparing the food for consumption. until placed in close proximity with a phase change device that produces sufficient heat or cold to “cook” or otherwise prepare the food for consumption. A transfer sheet 70 (or transfer shuttle 104) does not itself produce energy. It is here contemplated that one could implement a phase change device capable of large temperature cycling, and in this manner simultaneously provide both the functionality of the transfer sheet and of the phase change source, because it could nearly instantaneously NOT provide the temperature required for phase change. Therefore, for the purposes of protecting this less-desirable implementation: in one embodiment, the surface onto which viscous foodstuffs is dispensed shall be capable of a high-transient heat fluctuation between minimally affecting the phase change of the foodstuff and providing a phase change sufficient to prepare the foodstuff for consumption. It is also contemplated that the foodstuff could be in a molten state within the reservoir and therefore by leaving the reservoir and transport path (i.e. once dispensed) the material will simply cool. Therefore, in one embodiment the transport path (i.e. delivery tubes) are heated/cooled by delivery tube heater/cooler 33 and in this embodiment the ambient environment itself is capable of producing the phase change. In one embodiment the cook calibrates the device after loading it with a batch of foodstuffs by producing a test pattern, and then comparing the thickness of the test pattern to a reference image. Using selection buttons 42, the cook then increases or decreases the flow rate as dictated by the observed viscosity specific to the then-loaded batch of foodstuffs, as compared to the reference image. Thin test lines will require the system to reduce the plotting speed of printing shuttle 18, to increase the pressure in reservoirs 6, or to change the size of the opening through release nozzles 16 by adjusting solenoid 19. Once calibrated, the processor may then produce thicker or thinner lines as a means to scale the image to a desired size. In another embodiment a mechanical feeding mechanism, such as a screw is used to dispense foodstuffs from reservoirs 6. In one embodiment, a Z-axis control 50 (Z is approximately orthogonal to axes of motion of XY plotting mechanism 20) is provided, allowing release nozzles 16 to be displaced toward and away from the cooking surface. The ability to coordinate flow control with Z axis motion provides an additional level of control, especially with respect to origination and termination of lines, as well as allowing small portions of foodstuffs to be added within pre-existing fields while minimizing the added thickness because the added material may be placed more within the plane of the pre-existing field, rather than on top of it. In one embodiment the device continuously places dots of foodstuff, not unlike a pastry chef covering a cake surface with dots from a frosting bag. Utilizing these techniques the processor may produce detailed high-resolution custom images at high speed.

Shape Selection:

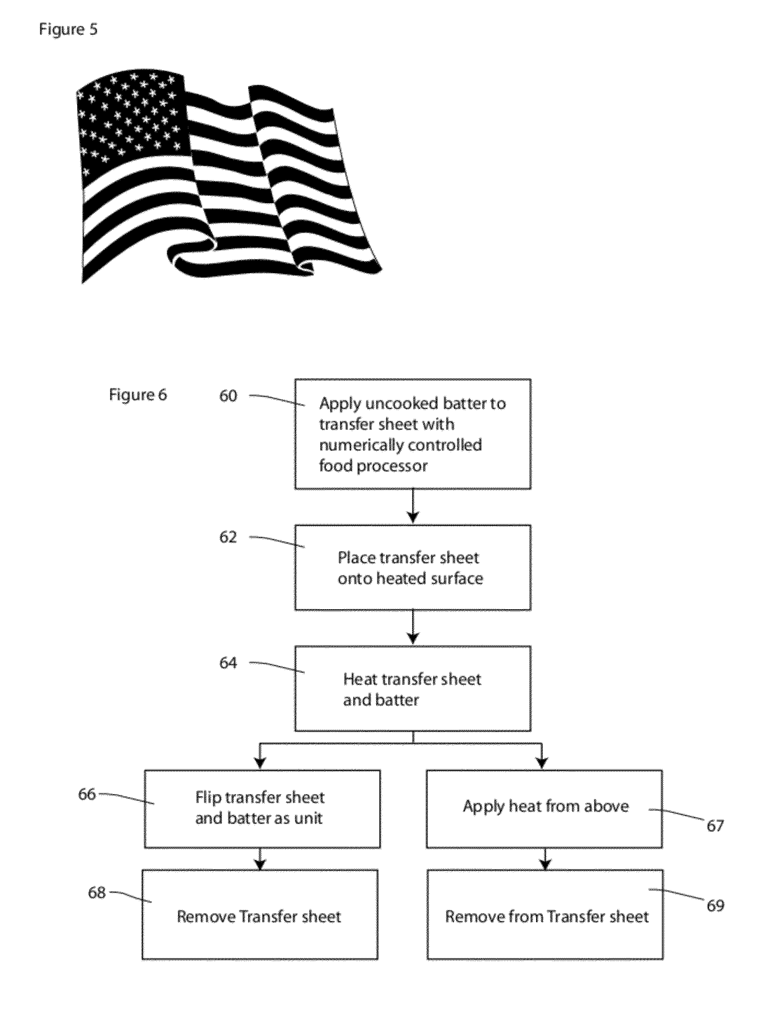

In one embodiment, the diner selects a desired food shape from a menu, as diners typically select any meal. In order to prepare the selection, a cook views a series of processed food options on display 40. These options can be names of images or the images themselves. The cook then selects the desired image and input any text that shall be associated with that image. In another embodiment, the cook may limit options to a subset of images applicable to the foodstuffs loaded within reservoirs 6. Using the pancake batter example above (i.e. the category of pancake batter in which one resevoir 6 contains undyed batter, one contains batter with red food coloring and one contains batter with blue food coloring) a list of options could include: the American flag flapping in the wind (i.e. FIG. 5), an American flag in a rectangular shape, a snowman with a candy cane, a dolphin, a flamingo, a bluebird, etc. Variously, the cook may search all images and then load reservoirs 6 to provide the colored batter necessary to produce the desired item. The cook may scroll through images by pressing selection buttons 42. In one embodiment the cook may create an image by drawing on the computer or by scanning, photographing or otherwise digitizing a pre-existing image (such as a team or company logo, child's drawing, photograph, or other personalized image, and have the processor and related software determine one or more “plots” paths for mobilizing the printing shuttle 18 to reproduce the image in food. In one embodiment the dining area 140 includes a plurality of markers or crayons 142 utilizing a plurality of colors 144 where the diners (ostensibly children) may make a drawing 146 of their choosing. Meanwhile, the reservoirs 6 are pre-loaded with food product that coincides with the specific plurality of colors 144 of the markers or crayons 142. As part of the cooking process, the drawings 146 are scanned. The scanned image is then printed for each diner to eat a customized meal representing their own drawing 146. Preprogrammed images may also be augmented with customized text. For example a birthday cake image may be augmented with the name and/or age of the person Anniversary celebrations may be customized with the names of the celebrants. Valentines hearts may include the names of the couple. The interface therefore includes the option of the cook entering names, dates, numbers and other customized text specific to the image.

The user may then select one form a plurality of path options (chosen for aesthetic reasons) or modify a portion of the plot path. An example of such algorithms exist within the manufacturing of custom metal parts, called “G-code.” The result of the shape selection is to enable a diner to eat a custom-shaped meal, either selected from a database or based on an image provided by the diner or the diner's representatives.

Processing:

In one embodiment, the device must be small and portable enough to be moved by hand and placed directly above a cooking surface. Processor 5 is lifted by handle 44 onto a griddle and heat resistant feet 12 are disposed below frame 14 to allow the device to sit directly on a griddle at full temperature. When the griddle temperature is sufficiently hot and the griddle surface has been prepared, the cook activates the controller 30 to directs the XY plotting mechanism 20 to move printing shuttle 18 in a predetermined pattern, as described above, opening and closing solenoids 19 to replicate the portions of the selected image that correlate with a first color (such as red). The system then offsets the printing shuttle 18 by offset distance X, as shown in FIG. 2, and repeats the process, if necessary, with the second and third colors, thereby producing athe desired an edible representation of the desired image. The offset distance X is the distance of nonalignment of release nozzles 16. Another embodiment may co-locate the release nozzles 16, eliminate offset X and utilize a switching method to switch between different resevoirs. In another embodiment, the device may have a single reservoir. The predetermined pattern that correlates with each image may include depositing foodstuffs intended to be darker. This process may include delaying the addition of foodstuffs of a single color, in order to produce outlines, accents and other graphical features created by virtue of a longer cooking time for the features intended to present as darker. Likewise, this technique may be used to provide graduations of color from a single resevoir 6.

Another embodiment, in which processor 5 may remain at a distance from the cooking surface, is described in FIG. 5.

FIG. 2 shows of the underside of printing shuttle 18. Release nozzles 16a, 16b and 16c are separated by an offset distance X. The openings of release nozzles 16a, 16b, and 16c are controlled by their respective solenoids 19a, 19b and 19c.

FIG. 3 shows solenoid 19 in a closed position so that no foodstuffs flow from tube 8 to release nozzles 16.

FIG. 4 shows solenoid 19 in a first open position (actuated to the right) with a high flow rate through big opening 45 so that foodstuffs maximally flow from tube 8 to release nozzle 16. If solenoid 19 were to be actuated all the way to the left, foodstuffs would flow at a reduced rate from tube 8 to release nozzles 16 through small opening 45.

FIG. 5 shows a numerically processed American flag pancake. White stripes are made of undyed batter. Red stripes are made of batter dyed red. The blue field is made of batter dyed blue. The stars are made of undyed batter.

Referencing FIG. 6, in one embodiment, pancakes are processed onto a transfer sheet such as a greased aluminum foil that is not yet sitting on the cooking surface as shown in Step 60. This method avoid over-cooking some areas of the dish while others are still being processed, allows the cooking surface to remain at full temperature, and (in some embodiments) allows processing unit 5 not to be located on the cooking surface. In step 62 the transfer sheet is moved onto a heated surface such as a grill or other full temperature cooking surface. (Note about nomenclature is used in this application: the distinction between a “transfer sheet” and “transfer shuttle” is simply that a transfer shuttle is constrained to transfer along a prescribed path. A transfer “sheet” can be considered generic, meaning it can be unconstrained or constrained.) Once the batter has cooked sufficiently in step 64, the transfer sheet and now semi-cooked batter are flipped as a unit onto the uncooked side. In step 68 the transfer sheet is removed and cooking continues normally. Variously, heat may be provided from above in step 67 and then removed from the transfer sheet in step 69, both as described in FIG. 8. Another example of using a transfer sheet 70 or shuttle 104 is to load the resevoirs with a ground potato mixture and produce letters, which may then be fried to produce french fries customized to a child's name (for example) or grilled to produce hash browns in the shape of a car, boat, dog, etc. In one embodiment a photograph is taken of the diner and used as the basis for a customized consumable.

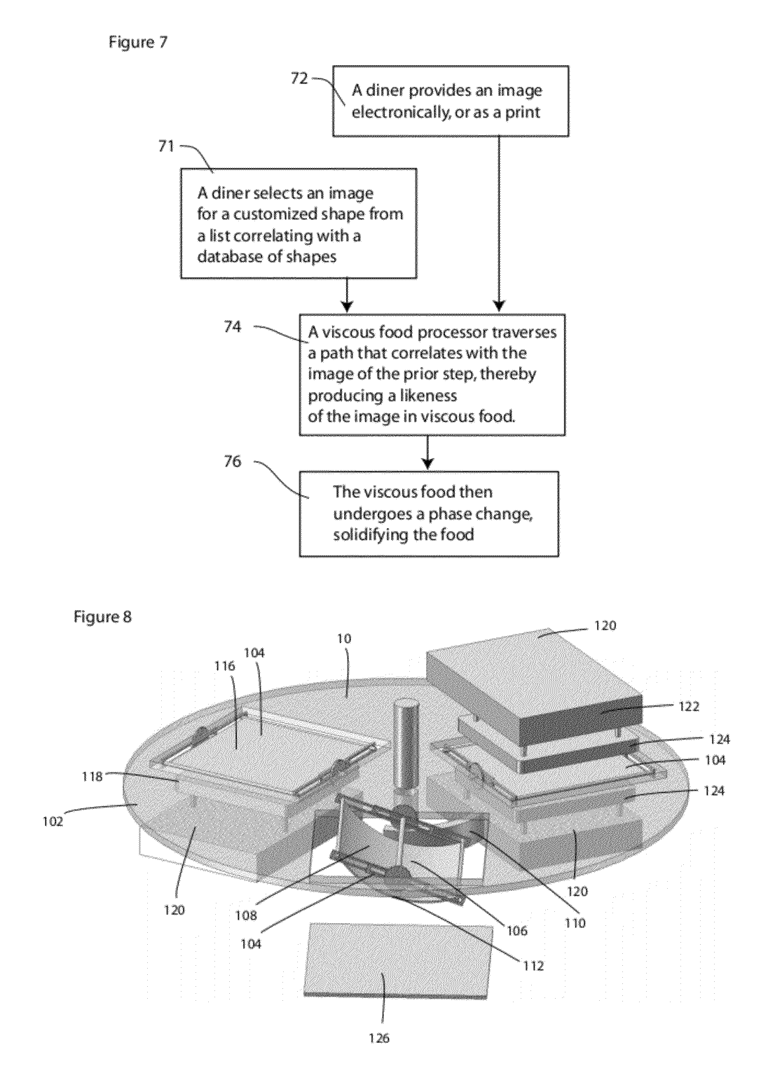

In FIG. 7, a diner arrives at the restaurant or venue and either selects an image for a customized consumable from a shape “menu”: a database of shapes in step 71 or provides to the cook a personal image such as a photograph, or graphic in Step 72. The image may be in a digital or printed format. If the latter, the image is scanned. In step 74, a viscous food processor traverses a path that correlates with the image of the prior step, thereby producing a likeness of the image in viscous food, as described elsewhere in this application. In step 76, the food undergoes a phase change to its final or “cooked” state. The phase change may be heating in the case of pancakes, french fries, pastries, etc. The phase change may be cooling in the case of candy, ice cream, etc. The diner may then consume a food of a customized shape without planning to consume said shape with the cook prior to the meal. An important aspect of this invention is the event of a restaurant or other food preparer responding to the desires of the patron in real time to provide a customized meal based on an image selected by the diner without preparation prior to the patron arriving for the meal.

FIG. 8 shows an embodiment of numerically controlled viscous foods processing system 10 shown with three stations. In this rotary embodiment, table 102 includes three shuttles 104. Each shuttle 104 includes a work surface 106 made of a bendable material such as a thin sheet of stainless steel, Teflon or silicone. The sheets are thin enough that heat can transmit through them readily and they do not have high thermal capacitance. Two of the edges are constrained, allowing surface 106 to bend, as shown at release station 108. As here embodied, ramp 110 engages drive wheel 112 which serves to rotate work surface 108 180° and outwardly flex work surface 108 by retracting support arm 114. If the work surface 108 is made of silicone support arms 114 may be extended thereby stretching work surface 108 and breaking the adhesion of the food, causing it to fall.

Printing station 116 is shown without the processor 5, shown in FIG. 1. For viscous materials cured by heat, such as pancake batter, a print phase change element 118 is used and disposed below processor 5. During the printing process, print phase change element 118 is advanced toward the lower surface of the shuttle 104 by actuator 120. The object is to provide sufficient temperature to prevent flow of the viscous material during printing, but to minimally cook the material. As an example, the appropriate temperature for pancake batter is approximately 110°-130°.

Once the printing process is complete, table 102 rotates clockwise advancing the printed food product to the phase change station 122. In the pancake example, phase change station 122 includes two cooking phase changers 124, one disposed above and one below table 102. Once shuttle 104 is correctly oriented, actuators 120 advance cooking phase changers 124 to be proximate to shuttle 104, and thereby cook the pancake. In this example, cooking phase changers 124 are approximately 325° for approximately 1 minute. The exact cook time varies as a function of the print time required at printing station, during which time some cooking occurs, whether or not a bi-level food is being compared, and to a lesser extent the specific recipe. The temperature and motions of cooking phase changers 124 are independent and maybe customized to optimize the cooking of the product specific to the item being prepared. Phase change station 122 may likewise be configured for cooling (for foods like ice cream or tempering chocolate). Phase changes driven by hot or cold air flow air, microwaves, pettier cooling and other heat transfer methods are contemplated.

Once the phase change process is complete, table 102 rotates clockwise, thereby advancing the already printed and phase changed food product to the release station 108. Again referencing the examples above, as table 102 rotates, drive wheel 112 engages ramp 110, thereby flexing (or stretching) shuttle 104 as it rotates 180°, thereby dislodging the pancake, causing it to fall to collection area 126. The activities at the three stations occur concurrently so that as one pancake is printed another is cooking and yet another being released, thereby providing a highly efficient yet customized food production station. The device described can fit on a standard 24 inch counter. For higher throughput of specific foods, one can add multiple print stations 116 and/or phase change stations 122, always with the objective of balancing the load of each process and thereby maximizing the output of the system 10. Complex phase changes may be implemented with multiple phase change stations 122.

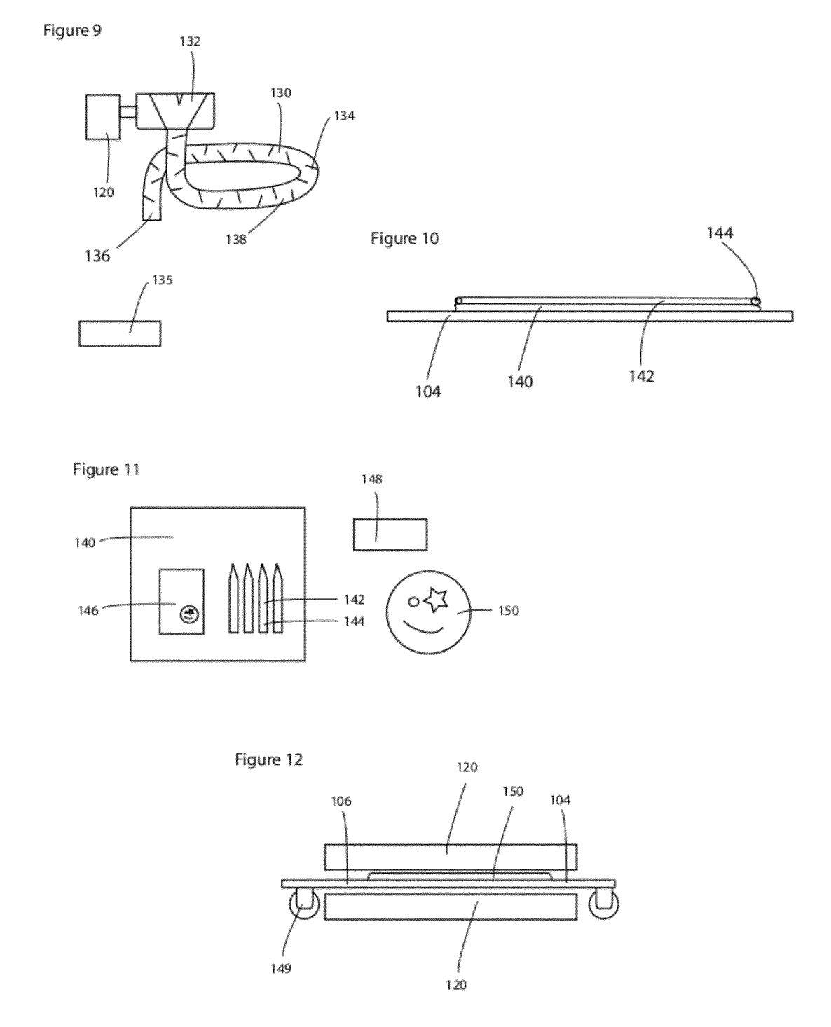

FIG. 9 shows a mixing unit 130. In order to produce additional mixtures of color and material beyond those contained within reservoirs 6, actuator 120 interposes mixing tube 130 between two release nozzles 16 and the build surface (i.e. transfer sheet 70 or shuttle 10). Inputs 132 are spaced by multiples of X as shown in FIG. 2, and seals to release nozzles 16. As foodstuff is dispensed from release nozzles 16 in a desired ratio, the two materials are forced through curved tube 138 where baffles 134 mix the viscous material to form a third color and/or substance that is a combination of the original two materials. Hence a limited number of reservoir colors (and/or materials) may be used to produce a much larger set of output colors (and/or materials). When changing colors or materials from one to another, mixing unit 30 is cleaned by expressing material onto purge area 135 until the newly desired color is prominent. The curved nature of tube 138 primary length and horizontal and/or above the level of dispensing outlets 16 minimizes the distance that Z-axis control 50 must actuate to allow mixing unit 130 to be utilized.

FIG. 10 shows a two level printed foodstuff. In order to provide a high-resolution printing and a relatively thick food, printing may be produced in two layers. In one embodiment, the first layer 140 contains the image as described previously. The second layer 142 is added to increase thickness and bulk of the meal. Second layer 142 may be printed more quickly than the first layer 140. In one embodiment, this is done by first tracing the outline of the image thereby creating a containment wall 144 and then filling the remaining shape. This may be performed with the containment wall 144 using a relatively high discuss the material and then filling the remaining shape with a relatively low viscosity material, the advantage being that the higher flow rate allows the printer to traverse fewer passes with the same fill rate. Therefore the pancake is printed upside down, with the good side of the image facing downwards as it is produced, and contact with the transfer sheet 70.

In one embodiment shown in FIG. 11, a dining area 140 includes a plurality of pens, markers or crayons 142 utilizing a specific plurality of colors 144 where the diners (ostensibly children) make a drawing 146 of their choosing. Meanwhile, reservoirs 6 are pre-loaded with food product that coincides with the specific plurality of colors 144 of the pens, markers or crayons 142. As part of the cooking process, the drawings 146 are digitized by scanner 148. The scanned image is then printed for each diner to eat a customized meal or dessert 150 representing their own drawing 146, as described in FIG. 7. An important aspect of this invention is the event of a restaurant or other food preparer responding to the desires of the patron in real time to provide a customized meal based on an image created by the diner without preparation prior to the patron arriving for the meal.

FIG. 12 shows a shuttle 104 in which work surface 106 is transported between stations with wheels 149. Shuttle 104 is shown between heaters 120 at phase change station 122.

The details of one or more embodiments of the invention are set forth in the accompanying drawings and the description below. Other features, objects, and advantages of the invention will be apparent from the description and drawings, and from the claims.

I claim:

1) A device for processing foods that are viscous in their ready-to-portion state into customized edible shapes including:
a. at least one resevoir containing a viscous foodstuff;
b. an XY plotting mechanism and associated electronics to manipulate at least one dispensing head;
c. a viscous foodstuff transport path from said at least one resevoir to said at least one dispensing head;
d. a dispensing head control means; to control the flow of the viscous foodstuff onto a surface;
e. a processor to control the XY plotting mechanism and dispensing head control means, such that a cook may produce as food in a customized shape, specific to each individual diner.

2) The device of claim 1 further including a Z axis control means to actuate said at least one dispensing head orthogonal to the axes of the XY plotting mechanism.

3) The device of claim 1 further including a plurality of resevoirs.

4) The device of claim 3 wherein the resevoirs each contain a different color or material of foodstuff.

5) The device of claim 4 wherein the foodstuff is pancake batter.

6) The device of claim 4 wherein the foodstuff is molten confection.

7) The device of claim 1 wherein the surface is a griddle.

8) The device of claim 1 wherein the surface is a transfer sheet or transfer shuttle.

9) The device of claim 1 wherein the customized shape includes text specific to the individual diner.

10) The device of claim 9 wherein the transfer sheet or transfer shuttle transfers between at least a printing and a phase change station.

11) The device of claim 1 further including a scanner or camera means to sample imagery on which to base customized shapes.

12) The device of claim 1 further including a camera to at least partially assist in control of dispensing foodstuff and/or locating the XY plotting mechanism.

13) A method for preparing custom-shaped food for a particular diner from a viscous foodstuff including the steps of:
a. selecting a desired shape from a plurality of reference images according to the desire of the diner;
b. initializing an XY plotter to traverse a path and simultaneously dispense the viscous foodstuff from said resevoir to a surface; and
c. enabling a phase change to said viscous foodstuff.

14) The method of claim 13 further including preparing a series of custom-shaped foods, each different for a plurality of diners at a single meal.

15) The method of claim 13 wherein the surface is a transfer sheet and the transfer sheet is placed in proximity of a heated surface to cook.

16) The method of claim 13 wherein the selected shape is based, at least in part, on an image provided by the diner and scanned to the XY plotter a digital representation.

17) The method of claim 13 wherein the viscous foodstuff is pancake batter and the custom-shaped food is a pancake.

18) The method of claim 13 wherein the viscous foodstuff is a confection.

19) A pancake making machine including an XY plotter that produces pancakes that are customized multi-color representations of images desired specifically by each customer.

20) The pancake making machine of claim 19 wherein each customer draws an image and the image is scanned to create the digital data utilized to drive the XY plotter to produce said pancakes.
